(19) United States
(12) Patent Application Publication
(10) Pub. No.: US 2016/0117548 A1
(43) Pub. Date: Apr. 28, 2016

(54) ELECTRONIC APPARATUS, METHOD AND STORAGE MEDIUM

(71) Applicant: Kabushiki Kaisha Toshiba, Tokyo (JP)

(72) Inventor: Daisuke Hirakawa, Saitama Saitama (JP)

(21) Appl. No.: 14/677,835

(22) Filed: Apr. 2, 2015

(30) Foreign Application Priority Data
Oct. 23, 2014 (JP) 2014-216152

(51) Int. Cl. G06K 9/00; G06K 9/18

(52) U.S. Cl. CPC G06K 9/00442; G06K 9/18

(57) ABSTRACT

According to one embodiment, a method includes receiving data associated with a first group of strokes and a second group of strokes of handwriting, associating first content with the first group of strokes, the first content determined based on information associated with the first group of strokes, and associating second content with the second group of strokes, the second content determined based on information associated with the second group of strokes. The first content is displayable or reproducible by a selection of the first group of strokes. The second content is displayable or reproducible by a selection of the second group of strokes.

### CROSS-REFERENCE TO RELATED APPLICATIONS

This application is based upon and claims the benefit of priority from Japanese Patent Application No. 2014-216152, filed Oct. 23, 2014, the entire contents of which are incorporated herein by reference.

### FIELD

Embodiments described herein relate generally to a technique for processing a handwritten document.

### BACKGROUND

In recent years, a technique for handwriting (inputting) a document on a screen of an electronic apparatus such as a tablet computer, a notebook personal computer, a smart phone, or a PDA has been known. A handwritten document in such a manner is stored in, e.g., a storage medium. In this electronic apparatus, for example, it is possible to display a past handwritten document on the screen of the electronic apparatus in accordance with, e.g., a user's instruction.

However, if the handwritten document stored in the storage medium is merely displayed, it is not much advantageous and not much convenient to a user, as compared with a document actually handwritten on, e.g., paper.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is a perspective view showing an example of an appearance of an electronic apparatus according to an embodiment;

FIG. 2 is a view showing an example of cooperation between the electronic apparatus and another apparatus;

FIG. 3 is a view showing an example of a document handwritten on a touch screen display;

FIG. 4 is a view showing an example of time-series information contained in the handwritten document;

FIG. 5 is a block diagram showing an example of a system configuration of the electronic apparatus;

FIG. 6 is a view showing an example of a home page image displayed by the electronic apparatus;

FIG. 7 is a view showing an example of a setting area displayed by the electronic apparatus;

FIG. 8 is a view showing an example of a note preview image displayed by the electronic apparatus;

FIG. 9 is a view showing an example of a page editing image displayed by the electronic apparatus;

FIG. 10 is a view showing an example of a search dialog displayed by the electronic apparatus;

FIG. 11 is a view showing an example of a function configuration of a handwritten note application program to be executed by the electronic apparatus;

FIG. 12 is a view for explaining a content association module in detail;

FIG. 13 is a view showing an example of a data structure of associated content information stored in a storage medium;

FIG. 14 is a flowchart showing an example of a procedure of a content associating processing;

FIG. 15 is a flowchart showing an example of a procedure of an associated content presenting processing;

FIG. 16 is a view for explaining an image which is displayed on a screen of the electronic apparatus in the case of presenting associated content;

FIG. 17 is a view for explaining another image which is displayed on the screen of the electronic apparatus in the case of presenting the associated content; and

FIG. 18 is a view showing an example of an image which is displayed on the screen of the electronic apparatus when a history of past associated content is presented.

### DETAILED DESCRIPTION

Various embodiments will be described hereinafter with reference to the accompanying drawings.

In general, according to one embodiment, a method includes: receiving data associated a first group of strokes and a second group of strokes of handwriting; associating first content with the first group of strokes, the first content determined based on information associated with the first group of strokes; and associating second content with the second group of strokes, the second content determined based on information associated with the second group of strokes. The first content is displayable or reproducible by a selection of the first group of strokes. The second content is displayable or reproducible by a selection of the second group of strokes.

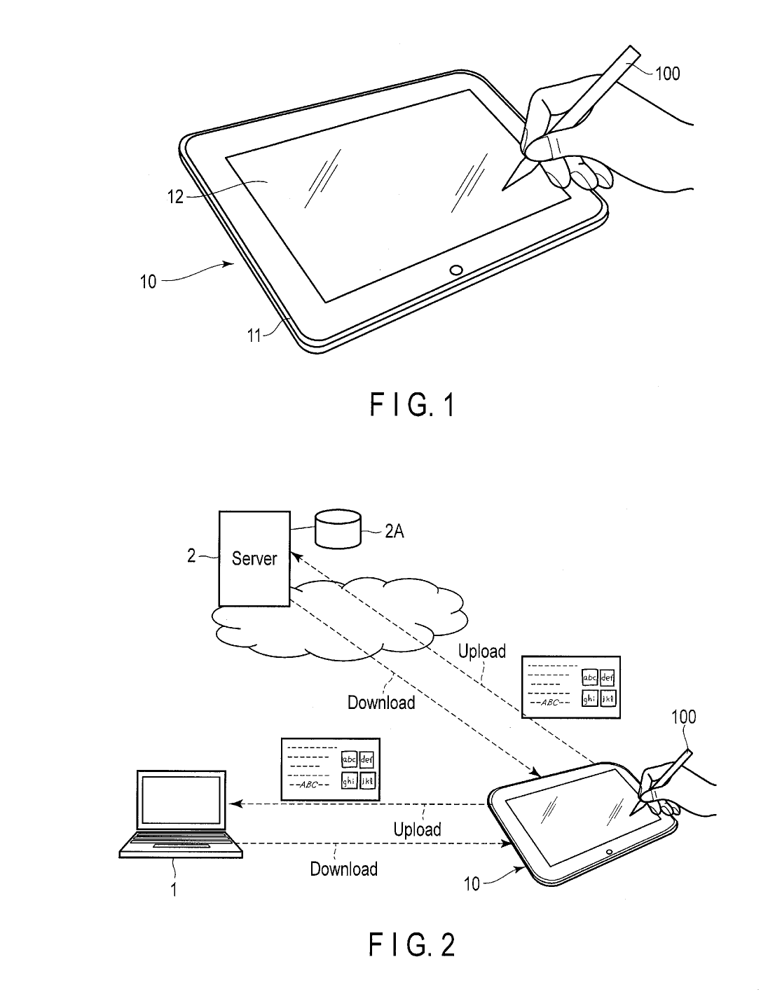

FIG. 1 is a perspective view showing an example of an appearance of an electronic apparatus according to an embodiment. This electronic apparatus is a portable pen-based electronic apparatus which allows handwriting input to be performed with, e.g., a pen or a finger. The electronic apparatus is provided as a tablet computer, a notebook personal computer, a smart phone, a PDA or the like. In an example shown in FIG. 1, the electronic apparatus is provided as a tablet computer. The following explanation is given with respect to the case where the electronic apparatus according to the embodiment is provided as a tablet computer. The tablet computer is a portable electronic apparatus which is also referred to as a tablet or a slate computer.

A tablet computer 10 as shown in FIG. 1 includes a main body 11 and a touch screen display 12. The main body 11 includes a housing formed in the shape of a thin box, and the touch screen display 12 is attached to the main body 11 such that it is laid over an upper surface of the main body 11.

In the touch screen display 12, a flat panel display and a sensor are incorporated, the sensor being formed to detect a contact position of the pen or finger on the screen of the flat panel display. The flat panel display may be provided as, e.g., a liquid crystal device (LCD). As the sensor, for example, a capacitance type touch panel and an electromagnetic induction type digitizer can be applied. The following explanation is given with respect to the case where two kinds of sensors, i.e., a touch panel and a digitizer, can be incorporated in the touch screen display 12. Thus, the touch screen display 12 can detect not only a touch operation by a finger of the user on the screen but that by a pen 100 on the screen.

The pen 100 may be provided as, e.g., a digitizer pen (electromagnetic induction pen). Using the pen 100, the user can perform a handwriting input operation on the touch screen display 12 (pen input mode). In the pen input mode, a stroke of the pen 100 which is given when being moved over the screen, i.e., a stroke given in handwriting with the pen 100, is determined, and thereby a plurality of strokes input in handwriting are displayed on the screen. When the pen 100 is moved while being in contact with the screen, this movement corresponds to a single stroke. Some strokes are given to form a character, a sign or the like. Thus, when a larger number of strokes corresponding to handwritten characters, a handwritten figure, a handwritten table, etc., are given, a hand-written document is formed.

In the above embodiment, the handwritten document is not image data, and is stored in a storage medium as data (handwritten document data) indicating a coordinate sequence of each of strokes and a relationship in order between the strokes. The handwritten document may be made based on image data. It should be noted that although the handwritten document will be described later in detail, it contains a plurality of stroke data (hereinafter referred to as time-series information) which indicates the order in which a plurality of strokes are given in handwriting, and also which are associated with the plurality of strokes, respectively. In other words, the time-series information contained in the handwritten document is a set of a plurality of time-series stroke data associated with the plurality of strokes, respectively. Each of the stoke data is associated with a respective one of the strokes, and includes coordinate data series (time-series coordinates) which are respectively associated with points in the above respective one of the stokes. The order in which those stroke data are arranged corresponds to the order in which their associated strokes are given in handwriting.

The tablet computer 10 can read an arbitrary existing handwritten document (time-series information) from the storage medium, and display the handwritten document, i.e., a plurality of strokes given to form the handwritten document, on the screen.

Furthermore, the tablet computer 10 according to the embodiment can be operated in a touch input mode for performing the handwriting input operation with a finger without using the pen 100. When the touch input mode is active, the user can perform the handwriting input operation on the touch screen display 12 with his or her finger. In the touch input mode, a stroke of the finger which is given when being moved over the screen, i.e., a stroke given in handwriting with the finger, is determined, and thereby a plurality of strokes given in handwriting are displayed on the screen.

The tablet computer 10 has an editing function. The editing function can delete or move an arbitrary handwritten part (a handwritten character, a handwritten mark, a handwritten figure, a handwritten table or the like) of a displayed handwritten document, which is selected by an area selection tool, in accordance with an editing operation by the user using an “eraser” tool, the area selection tool, various tools, etc. Also, the arbitrary handwritten part in the handwritten document which is selected by the area selection tool can be specified as a search key for searching for another handwritten document. Furthermore, the arbitrary handwritten part selected by the area selection tool can be subjected to recognition processing such as recognition of a written character, a handwritten figure or a handwritten table.

In the embodiment, the handwritten document can be managed as a single page or a plurality of pages. In this case, it may be set that the handwritten document (time-series information) is divided into portions each of which can be located within the area of a single image on the screen, and time-series information located within the area of a single image are recorded as a single page. In addition, it may be set that the size of the page can be changed. In this case, since the size of the page can be set greater than that of the screen, a written document having a greater size than that of the screen can be handled as a single page. If a single page cannot entirely be displayed, it may be set that the page is displayed while being reduced in size, and a portion thereof to be displayed is moved by a vertical and horizontal scroll.

FIG. 2 shows an example of cooperation between the tablet computer 10 and an external apparatus. The tablet computer 10 can perform wireless communication with a personal compute 1. Using a wireless communication device, the tablet computer 10 can also perform communication with a server 2 on the Internet. The server 2 may be provided as a server which offers an online service and various cloud computing services.

The personal computer 1 includes a storage device such as a hard disk drive (HDD). The tablet computer 10 can transmit a written document to the personal computer 1, and record it in the HDD of the personal computer 1 (upload). In order to ensure secure communication between the tablet computer 10 and the personal computer 1, the personal computer 1 may be set to authenticate the tablet computer 10 at the time of starting communication. In this case, a dialog which urges the user to input ID or a password may be displayed on the screen of the tablet computer 10, or ID of the tablet computer 10 or the like may be automatically transmitted from the tablet computer 10 to the personal computer 1.

This enables the tablet computer 10 to handle a large number of elements of the time-series information or a large amount of time-series information even if the capacity of storage in the tablet computer 10 is small.

Also, the tablet computer 10 can read one or more arbitrary handwritten documents recorded in the HDD of the personal computer 1 (download), and display the read handwritten document (a plurality of strokes given to form the document) on the screen of the touch screen display 12 of the tablet computer 10. In this case, a list of thumbnails obtained by reducing the handwritten documents may be displayed on the screen of the touch screen display 12, and a selected one of the thumbnails may be displayed in normal size on the screen of the touch screen display 12.

Furthermore, as described above, the tablet computer 10 may communicate with the server 2 on a cloud which offers a storage service, etc., instead of with the personal computer 1. The tablet computer 10 can transmit a handwritten document to the server 2 through the Internet to have it recorded in a storage device 2A of the server 2 (upload). Furthermore, the tablet computer 10 can read arbitrary handwritten document recorded in the storage device 2A of the server 2 (download), and display strokes given to form the handwritten document on the touch screen display 12 of the tablet computer 10.

In such a manner, in the embodiment, as the storage medium in which the handwritten document is stored, any of a storage device in the tablet computer 10, that in the personal computer 1 and that in the server 2 may be applied.

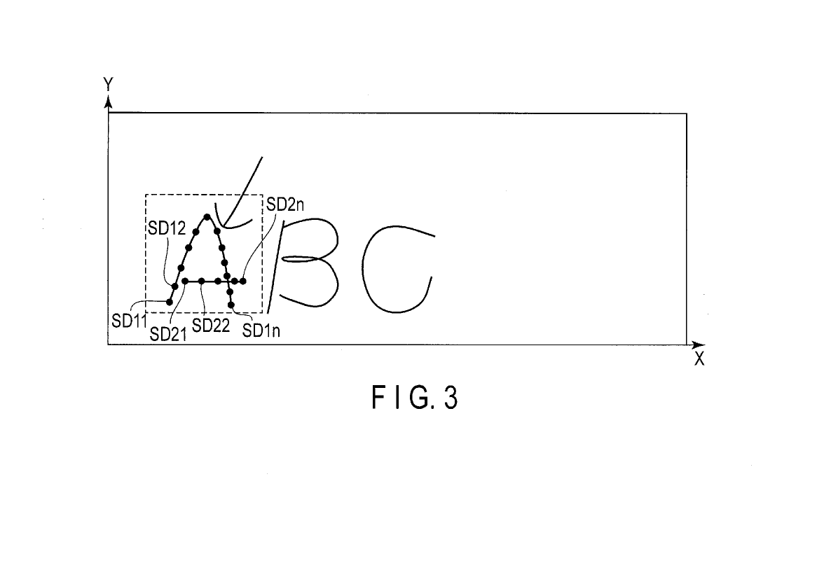

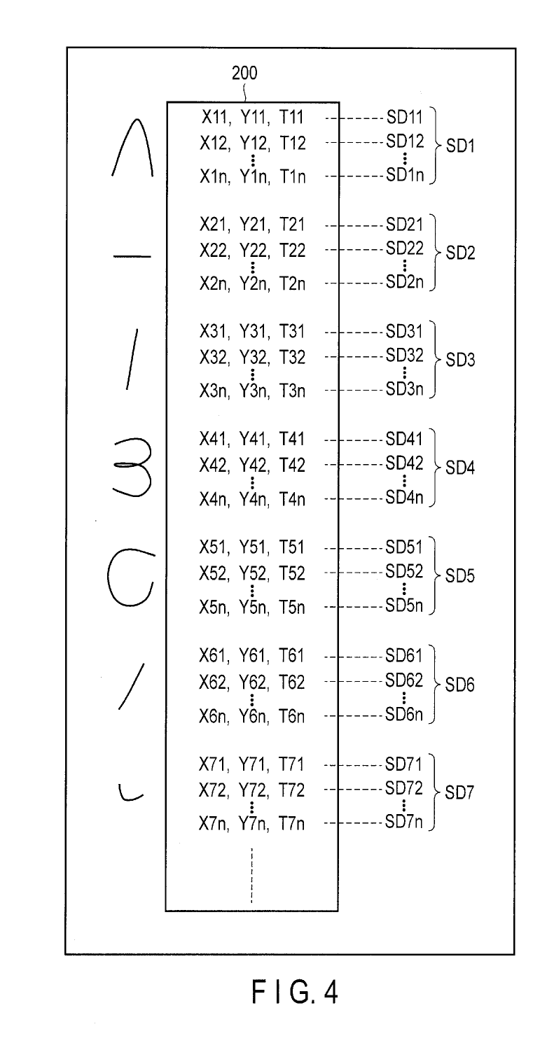

Next, a relationship between a handwritten document and strokes (a character, a figure, a table or the like) given in handwriting by the user will be explained with reference to FIGS. 3 and 4. FIG. 3 shows an example of a document (a handwritten character string) handwritten with the pen 100 or the like on the touch screen display 12.

As is often the case with, with respect to a handwritten document, after a character, a figure or the like is handwritten, another character, figure or the like is handwritten on the former handwritten character, figure or the like. Referring to FIG. 3, the characters “A”, “B” and “C” are handwritten, and an arrow is then handwritten close to the handwritten character “A”.

The handwritten character “A” is formed by two strokes given in handwriting with the pen 100 (a stroke given to form “ [symbol] ”, i.e., the “ [symbol] ” stroke, and a stroke given to form “-”, i.e., the “-” stroke). The first stroke of the pen 100 given in handwriting to form “ [symbol] ” is sampled in real time at, e.g., regular intervals, thereby obtaining time-series coordinates SD11, SD12, . . . SD1n of the “ [symbol] ” stroke. Similarly, the stroke of the pen 100 given to form “-” is also sampled in real time at regular intervals, thereby obtaining time-series coordinates SD21, SD22, . . . SD2n of the “-” stroke.

The handwritten character “B” is formed by two strokes given in handwriting with the pen 100 or the like. The character “C” is formed by a single stroke given in handwriting with the pen 100 or the like. The handwritten arrow is formed by two strokes given in handwriting with the pen 100 or the like.

FIG. 4 shows time-series information 200 (i.e., a set of stroke data) included in the handwritten document as shown in FIG. 3. The time-series information 200 as shown in FIG. 4 includes a plurality of stroke data SD1, SD2, . . . SD7. In the time-series information 200, the stroke data SD1, SD2, . . . SD7 are arranged on a times series basis in the order in which their associated strokes are given in handwriting.

In the time-series information 200, the first two stroke data SD1 and SD2 indicate two strokes given to form the handwritten character “A”. The third and fourth stroke data SD3 and SD4 indicate two strokes given to form the handwritten character “B”. The fifth stroke data SD5 indicates a single stroke given to form the handwritten character “C”. The sixth and seventh stroke data SD6 and SD7 indicate two strokes given to form the handwritten arrow.

Each of the stroke data includes a coordinate data sequence (time-series coordinates) corresponding to an associated single stroke, i.e., a plurality of coordinates corresponding to a plurality of sampling points in the associated single stroke. In each stroke data, coordinates of the plurality of sampling points are arranged on a time-series basis in order in which they are located when the associated single stroke is given (in order in which they are sampled). For example, with respect to the handwritten character “A”, the stroke data SD1 includes a coordinate data sequence (times-series coordinates) corresponding to points in the stroke given to form “ [symbol] ” of the handwritten character “A”, i.e., it includes n coordinate data SD11, SD12, . . . SD1n. The stroke data SD2 includes a coordinate data sequence corresponding to points in the stroke given to form “-” of the handwritten character “A”, i.e., it includes n coordinate data SD21, SD22, . . . SD2n. It should be noted that the number of coordinate data may vary from one stroke data to another. When strokes are sampled at regular intervals, the number of sampling points varies from one stroke to another. This is because the strokes have different lengths.

Each of the coordinate data indicates an X coordinate and a Y coordinate of a given point in an associated stroke. For example, coordinate data SD11 indicates an X coordinate (X11) and a Y coordinate (Y11) of a starting point of the “ [symbol] ” stroke. Coordinate data SD1n indicates an X coordinate (X1n) and a Y coordinate (Y1n) of an ending point of the “ [symbol] ” stroke.

Also, each coordinate data includes time stamp information T associated with a point of time at which handwriting is performed to reach a point whose coordinates are indicated by said each coordinate data. The above point of time may be determined as absolute time (e.g., year, month, day, hour, minute and second) or relative time with respect to a given point of time. For example, it may be set that absolute time of starting to give a stroke is added as time stamp information to associated stroke data, and in addition relative time indicating a difference between the absolute time and time at which associated coordinates are obtained is added as time stamp information T to an associated one of coordinate data in the stroke data.

Due to use of time-series information 200 in which time stamp information T is added to each coordinate data, a relationship in time between strokes can be indicated with a more accuracy. Furthermore, by virtue of such time-series information 200, for example, it is possible to specify a time period in which a specific group of strokes for forming a handwritten document were given (input) in handwriting (i.e., a time period in which a group of stroke data associated with the group of strokes were input).

It should be noted that although it is not shown in FIG. 4, information (Z) indicating a pen pressure is added to each coordinate data.

The time-series information 200, which has such a structure as explained with reference to FIG. 4, can indicate not only the matter of writing (handwriting) with respect to each of strokes but a relationship in time between the strokes. Therefore, due to use of the time-series information 200, even if an arrow is handwritten such that its distal end portion is located on or close to the handwritten character “A” as shown in FIG. 3, the handwritten character “A” and the handwritten arrow can be considered as separate symbols, i.e., they can be distinguished from each other.

Furthermore, in the embodiment, as described above, the handwritten document includes time-series information 200, which is a set of time-series stroke data, not a result of recognition of an image or a character. Thus, a handwritten character can be handled regardless of in what language it is handwritten. Therefore, the structure of the time-series information 200 according to the embodiment can be used in common by various countries in the world.

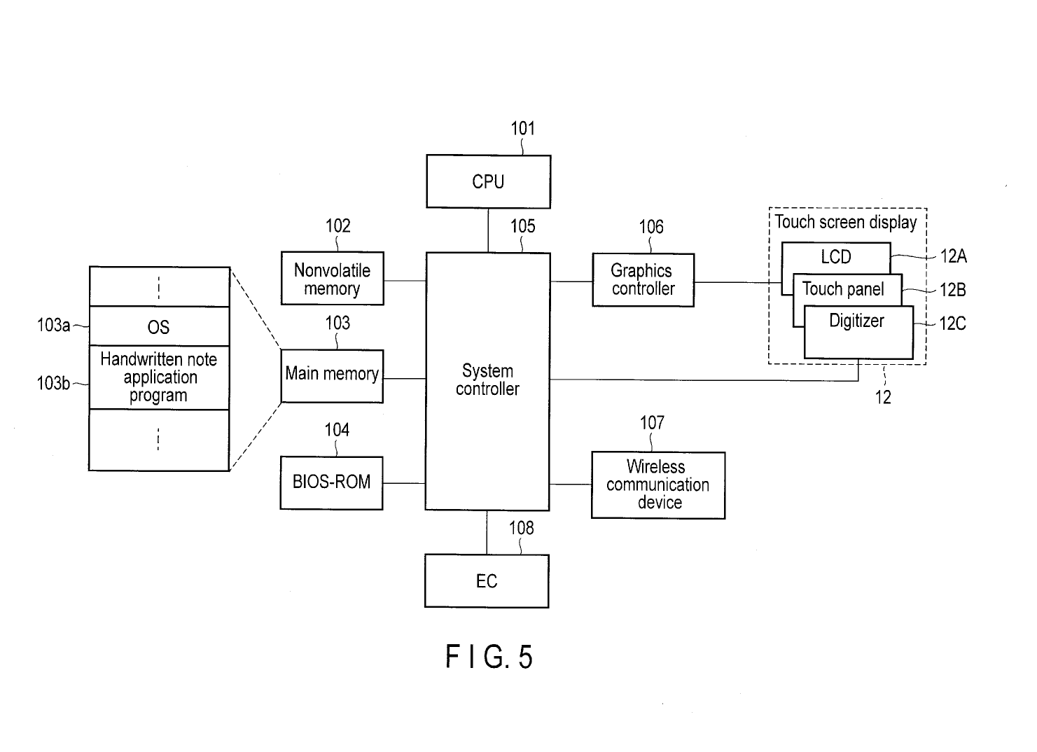

FIG. 5 is a view showing a system configuration of the tablet computer 10. As shown in FIG. 5, the tablet computer 10 includes a CPU 101, a nonvolatile memory 102, a main memory 103, a BIOS-ROM 104, a system controller 105, a graphics controller 106, a wireless communication device 107, an EC 108, etc. In the tablet computer 10, the touch screen display 12 as shown in FIG. 1 includes an LCA 12A, a touch panel 12B and a digitizer 12C.

The CPU 101 is a processor which controls operations of various modules in the tablet computer 10. The processor includes at least one circuitry. Also, the CPU 101 executes various software each loaded into the main memory 103 from the nonvolatile memory 102, which is a storage device. Each software includes an operating system (OS) 103a and various application programs. The various application programs include a handwritten note application program 103b.

The handwritten note application program 103b has a function of making and displaying such a handwritten document as described above, a function of editing the handwritten document, a function of searching for a handwritten document including a desired handwritten portion or for a desired handwritten portion of a given handwritten document, etc.

Also, the handwritten note application program 103b further has a function of associating groups of strokes in a document handwritten by the user with the pen 100 or the like, as described above, with content specified based on the groups of strokes.

The CPU 101 executes a basic input output system (BIOS) stored in the BIOS-ROM 104. The BIOS is a program for controlling hardware. The system controller 105 is a device which connects a local bus for the CPU 101 and various component modules. The system controller 105 incorporates a memory controller which controls access to the main memory 103. The system controller 105 has a function of performing communication with a serial bus compliant with PCI EXPRESS standard.

The graphics controller 106 is a display controller which controls the LCA 12A, which is used as a display monitor of the tablet computer 10. A display signal produced by the graphics controller 106 is sent to the LCA 12A. The LCA 12A displays a screen image in response to the display signal. The LCA 12A, the touch panel 12B and the digitizer 12C are stacked together. The touch panel 12B is a capacitance type of pointing device for performing inputting on a screen of the LCA 12A. A position, movement, etc. of a finger contacting the screen are detected by the touch panel 12B. The digitizer 12C is an electromagnetic induction type of pointing device for performing inputting on the screen of the LCA 12A. A position, movement, etc. of the pen (digitizer pen) 100 contacting the screen are detected by the digitizer 12C.

The wireless communication device 107 is a device configured to execute wireless communication such as wireless LAN communication or a 3G mobile communication.

The EC 108 is a one-chip microcomputer including an embedded controller for power management. The EC 108 has a function of powering up or down the tablet computer 10 in accordance with an operation by the user on a power button.

Next, some typical examples of an image provided for the user according to the handwritten note application program 103b will be explained.

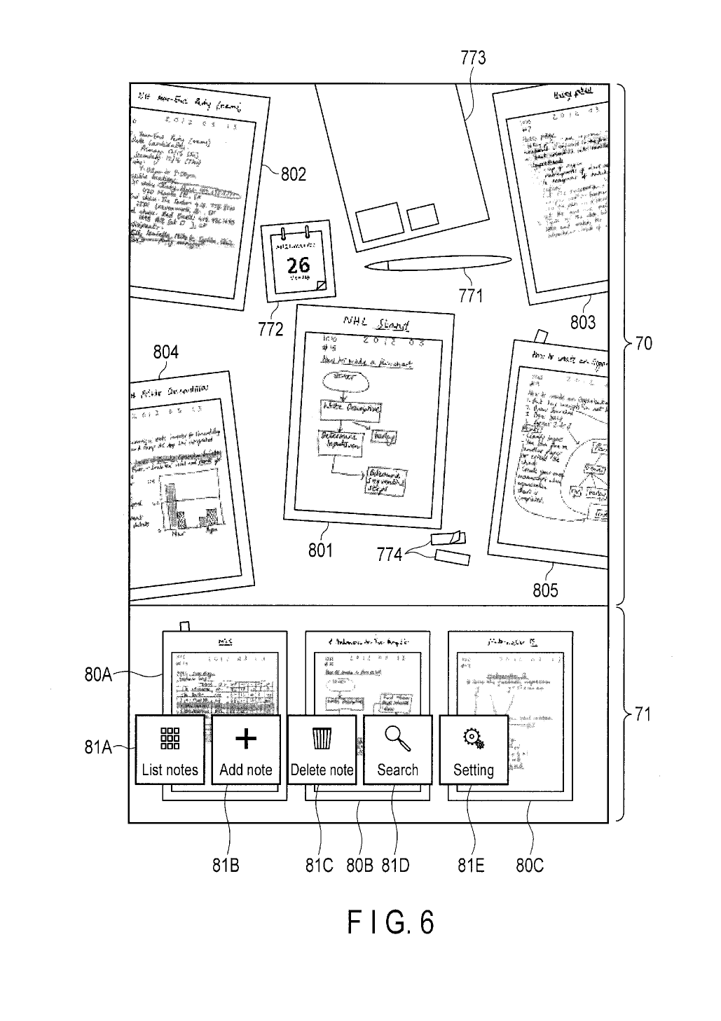

FIG. 6 shows an example of a home image provided with the handwritten note application program 103b. The home image is a basic image which is provided to handle a plurality of handwritten documents (handwritten notes), and based on which the handwritten documents can be managed, and an entire setting of an application can be performed.

The home image includes a desktop area 70 and an extended area 71. The desktop area 70 is a temporary area for displaying a plurality of note icons 801-805 associated a plurality of handwritten documents which are in active use. In each of the note icons 801-805, a thumbnail of a given page of an associated handwritten document is displayed. In the desktop area 70, a pen icon 771, a calendar icon 772, a scrapbook (gallery) icon 773 and a tag (label) icon 774 are further displayed.

The pen icon 771 is a graphical user interface (GUI) for switching the image to be displayed, from the home image to a page editing image. The calendar icon 772 is an icon indicating a present date. The scrapbook icon 773 is a GUI for viewing data (scrapbook data or gallery data) fetched from another application program or an external file. The tag icon 774 is a GUI for attaching a label (tag) to an arbitrary page of arbitrary handwritten document.

The extended area 71 is a display area for viewing storage areas for storing all created handwritten documents. In the extended area 71, note icons 80A, 80B and 80C associated with some of all the handwritten documents are displayed. In each of the note icons 80A, 80B and 80C, a thumbnail of a given page in an associated handwritten document is displayed. The handwritten note application program 103b can detect a motion (e.g., swiping) of a finger of the user or the pen 100 for use by the user on the extended area 71. In response to detection of the motion (e.g., swiping), the handwritten note application program 103b leftwards or rightwards scrolls a screen image on the extended area 71. Thereby, in the extended area 71, note icons associated with arbitrary handwritten documents can be displayed.

The handwritten note application program 103b can detect another motion (e.g., tapping) of the finger of the user or the pen 100 for use by the user on a note icon in the extended area 71. In response to detection of the other motion (e.g., tapping) on the note icon in the extended area 71, the handwritten note application program 103b moves the note icon to a center portion of the desktop area 70. Then, the handwritten note application program 103b selects a handwritten document associated with the note icon, and displays a note preview image which will be described later, in place of a desktop image. The note preview image is an image in which an arbitrary page or pages in the selected handwritten document can be viewed.

Furthermore, the handwritten note application program 103b can also detect a motion (e.g., tapping) of the finger of the user or the pen 100 for use by the user on the desktop area 70. To be more specific, when detecting a motion (e.g., tapping) of the finger or the pen 100 on a note icon located at the center portion of the desktop area 70, the handwritten note application program 103b selects a handwritten document associated with the note icon located at the center portion, and displays the above note preview image in place of the desktop image.

In the home image, a menu can be displayed. The menu includes a List notes button 81A, an Add note button 81B, a Delete note button 81C, a Search button 81D and a Setting button 81E, which are to be displayed in a lower portion of the image, e.g., in the extended area 71. The List notes button 81A is a button for displaying a list of handwritten documents. The Add note button 81B is a button for creating (adding) a new written document. The Delete note button 81C is a button for deleting a handwritten document. The Search button 81D is a button for opening a search image (search dialog). The Setting button 81D is a button for opening a setting image of an application.

It should be noted that in the home image, when the Add note button 81B is tapped by the finger or the pen 100, a handwritten document (note) creation image is displayed. In the creation image, a title section is provided, and a name of the handwritten document can be input to the title section in handwriting. It is also possible to select a front cover of the handwritten document and a kind of sheet therefor. Then, when a add button provided on the creation image is pressed, a new handwritten document is created, and located in the extended area 71.

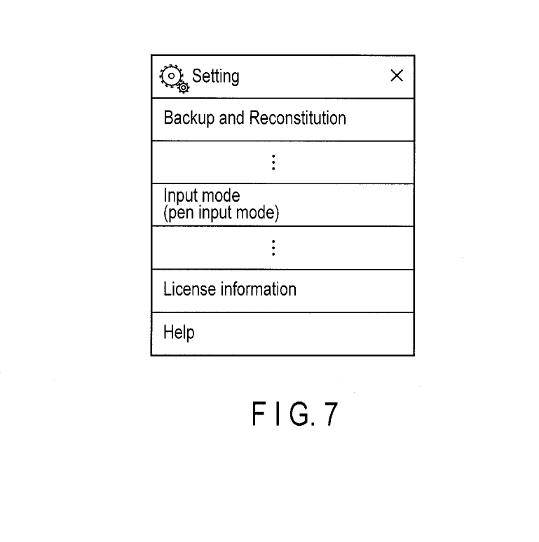

FIG. 7 shows an example of a setting image which is displayed when the Setting button 81E is tapped by the finger or the pen 100. In the setting image, various setting items are displayed. The setting items include the items “backup and reconstitution”, “input mode (pen input mode or touch input mode)”, “license information”, “help”, etc.

It should be noted that although it is not shown in FIG. 6, a return button, a home button, a recent application button, etc., are displayed in an area in the home image as shown in FIG. 6, which is located in a lower position than the extended area 71.

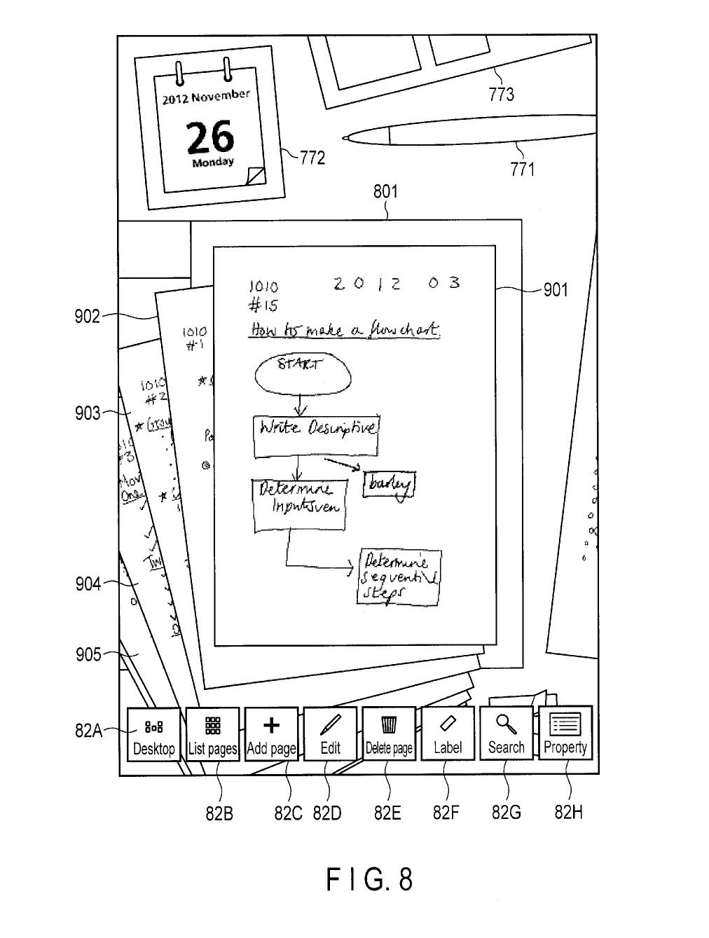

FIG. 8 shows an example of the above note preview image. The note preview image is an image in which an arbitrary page or pages of a selected handwritten document can be viewed. The following explanation is given with respect to the case of selecting a handwritten document associated with the note icon 801 in the desktop area 70 in the home image. In this case, the handwritten note application program 103b displays a plurality of pages 901-905 included in the handwritten note such that at least some portions of the pages 901-905 can be visually recognized and the pages 901-905 are overlaid.

In the note preview image, the pen icon 771, the calendar icon 772 and the scrapbook icon 773 are further displayed.

Also, in the note preview image, a menu can be displayed in a lower portion of the image. The menu includes a Desktop button 82A, a List pages button 82B, a Add page button 82C, a Edit button 82D, a Delete page button 82E, a Label button 82F, a Search button 82G, and a Property button 82H. The Desktop button 82A is a button for closing the note preview image and displaying the home image. The List pages button 82B is a button for displaying a list of pages of a presently selected handwritten document. The page Add page button 82C is a button for creating (adding) a new page in the handwritten document. The Edit button 82D is a button for displaying a page editing image. The Delete page button 82E is a button for deleting a page in the handwritten document. The Label button 82F is a button for displaying a list of kinds of labels which can be applied. The Search button 82G is a button for displaying a search image. The Property button 82H is a button for displaying property of the handwritten document.

The handwritten note application program 103b can detect various motions of the user on the note preview image. For example, in response to detection of a given motion, the handwritten note application program 103b changes the page to be displayed uppermost to an arbitrary page (page feed, page return). Furthermore, in response to detection of a given motion (e.g., tapping) on the uppermost page, or on the pen icon 771 or on the Edit button 82D, the handwritten note application program 103b selects the uppermost page, and displays the page editing image in place of the note preview image.

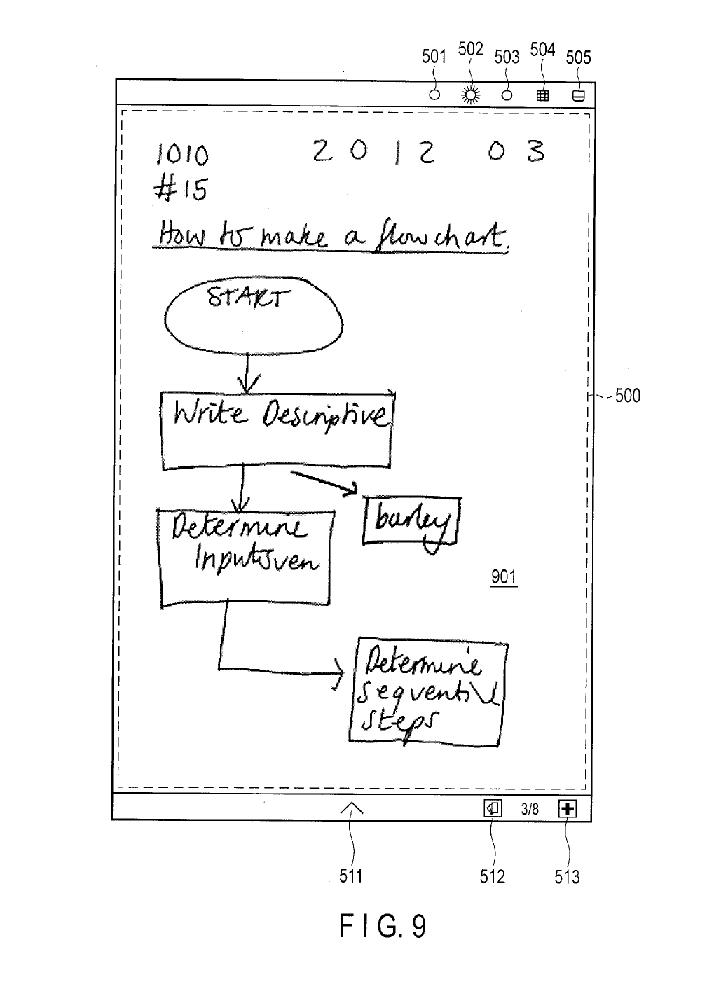

FIG. 9 shows an example of the page editing image. The page editing image is an image in which a new page can be created in the handwritten document or an existing page thereof can be viewed and edited. If a page 901 on the note preview image as shown in FIG. 8 is selected, the contents of the page 901 are displayed in the page editing image as shown in FIG. 9.

In the page editing image, a rectangular area 500 surrounded by a broken line is a handwriting input area in which the user can input a stroke or the like in handwriting. In the handwriting input area 500, an input event from the digitizer 12C is used to display (draw) a stroke; i.e., it is not used as an event indicating a motion such as tapping. On the other hand, in an area other than the handwriting input area 500 in the page editing image, an input event from the digitizer 12C can also be used as an event indicating a motion such as tapping.

An input event from the touch panel 12B is not used to display (draw) a stroke; i.e., it is used as an event indicating a motion such as tapping or swiping.

Furthermore, in the page editing image, a quick selection menu which includes three kinds of pens 501-503 registered in advance by the user, an area selection pen 504 and an eraser pen 505 is displayed in an upper portion of the image which is located upward of the handwriting input area 500. The following explanation is given with respect to the case where a black pen 501, a red pen 502 and a marker 503 are registered in advance by the user. The user can switch the kind of the pen to be used, by taping a pen (button) in the click selection menu with a finger or the pen 100. For example, when a handwriting input operation is performed using the pen 100 on the page editing image, for example, with the black pen 501 selected by tapping with the finger or the pen 100, the handwritten note application program 103b displays a black stroke on the page editing image in accordance with movement of the pen 100.

The above three kinds of pens in the quick selection menu can also be switched by performing an operation on a side button (not shown) of the pen 100. The color and thickness of each of the three kinds of pens in the quick menu can be set in combination to a color and a thickness frequently applied.

In addition, in the page editing image, a Menu button 511, a Return page (return to the note preview image) button 512 and a Add new page button 513 are displayed in a lower portion of the image outside the handwriting input area 500. The menu button 511 is a button for displaying a menu.

In this menu, the following buttons may be displayed: e.g., a button for putting an indicated page in the Trash; a button for pasting a copy or part of a cut page; a button for opening a search image; a button for displaying an export sub-menu; a button for displaying an import sub-menu; a button for converting a page into text, and mailing it; and a button for displaying a pen case. The export sub-menu is provided in order for the user to select, for example, a function of recognizing a page displayed on the page editing image and converting it into an electronic document file, a presentation file, an image file or the like, or a function of converting a given page into an image file and sharing it with another application. The import sub-menu is provided in order for the user to select, for example, a function of importing a memo from a memo gallery or a function of importing an image from a gallery. The pen case is a button for invoking a pen setting image in which the color (the color of a line to be drawn) and thickness (the thickness of the line to be drawn) of each of the three kinds of pens in the quick selection menu can be changed.

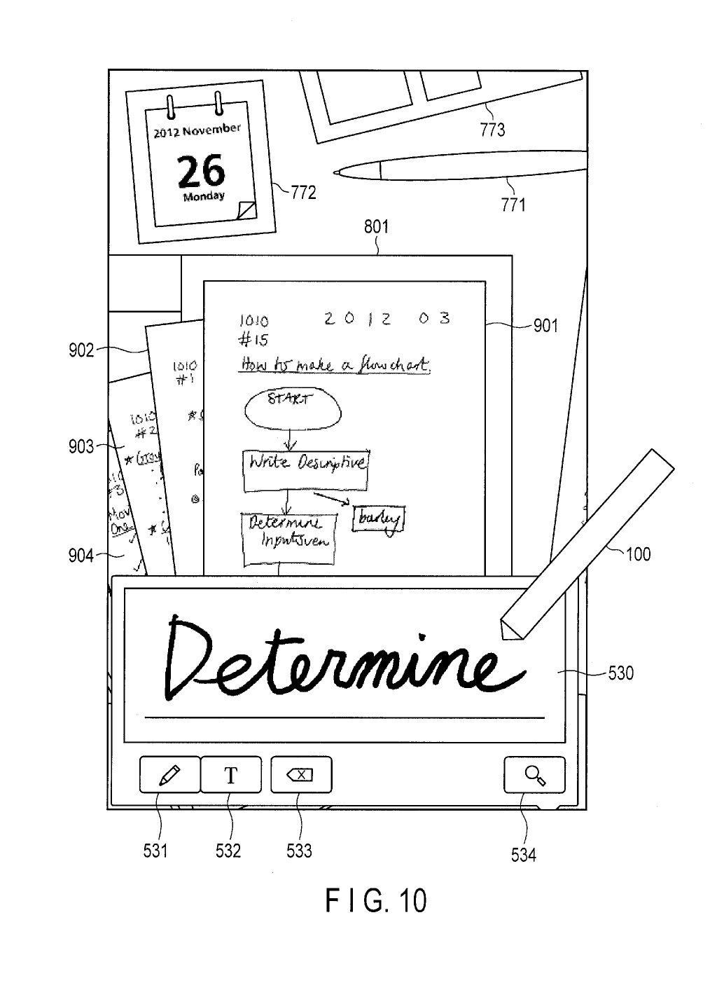

FIG. 10 shows an example of the above search image (search dialog). To be more specific, FIG. 10 shows the case where the Search button 82G on the note preview image as shown in FIG. 8 is selected, and a search image is opened on the note preview image.

In the search image, a search key input area 530, a handwriting search button 531, a text search button 532, a delete button 533 and a search execution button 534 are displayed. The handwriting search button 531 is a button for selecting a handwriting search. The text search button 532 is a button for selecting a text search. The search execution button 534 is a button for requesting execution of search processing.

In the handwriting search, the search key input area 530 is used as an input area in which a character string, a figure or a table is to be handwritten as a search key. Referring to FIG. 10, the handwritten character string “Determine” is input as a search key. The user can handwrite not only the handwritten character string, but also a figure, a table or the like with the pen 100 in the search key input area 530. If the handwritten character string “Determine” is input in the search key input area 530, and in this state, the search execution button 534 is selected by the user, a handwriting search is performed using stroke set given to form “Determine” (a query stroke set), in order to search for a handwritten document containing a stroke set corresponding to the query stroke set. In the handwriting search, a stoke set similar to the query stroke set are searched for due to matching between strokes. Also, in the case of calculating a similarity between the above stroke set and the query stroke set, a dynamic programming (DP) matching may be applied.

In the text search, for example, a software keyboard is displayed on the screen. The user can input arbitrary text (character string) as a search key to the search key input area 530 by operating the software keyboard. If the search execution button 534 is selected by the user, with a given text input as a search key to the search key input area 530, a search for a handwritten document containing a stroke set expressing the text (query text) is performed as the text search.

The handwriting search or the text search may be performed on all handwritten documents, or only on a selected handwritten document. When the handwriting search or the text search is performed, a search result image is displayed. In the search result image, a list of handwritten documents (pages) containing a stroke set corresponding to the query stroke set (or query text) is displayed. It should be noted that a hit word (a stroke set corresponding to the query stroke set or the query text) is highlighted.

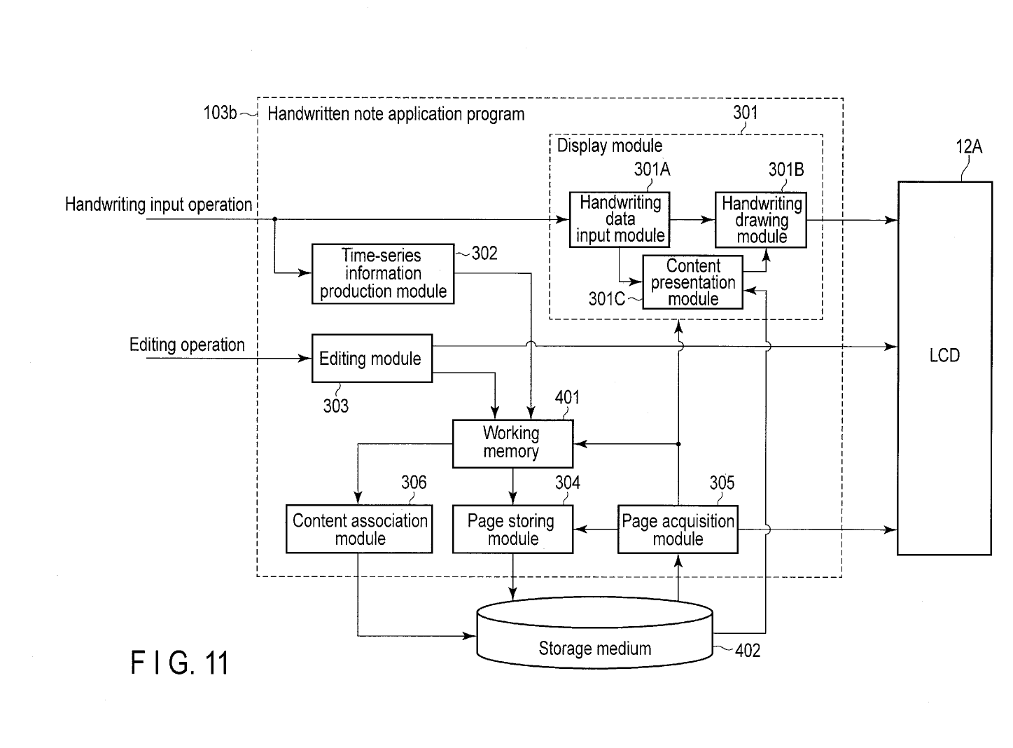

Next, a function configuration of the handwritten note application program 103b to be executed by the tablet computer 10 will be explained with reference to FIG. 11.

The handwritten note application program 103b is a WYSIWYG application which can handle a handwritten document. The handwritten note application program 103b includes, for example, a display module 301, a time-series information production module 302, an editing module 303, a page storing module 304, a page acquisition module 305, a content association module 306, the content association module 306, a working memory 401, etc.

The touch panel 12B is configured to detect an event such as “touch (contact)”, “movement (slide)” or “release”. The “touch (contact)” is an event indicating that an object (the finger) contacts the screen. The “movement (slide)” is an event indicating that the contact position is shifted while the object (the finger) is in contact with the screen. The “release” is an event indicating that the object (the finger) is separated from the screen.

The digitizer 12C, as well as the touch panel 12B, is configured to detect an event such as “touch (contact)”, “movement (slide)” or “release”. The “touch (contact)” is an event indicating that an object (the pen 100) contacts the screen. The “movement (slide)” is an event indicating that the contact position is shifted while the object (the pen 100) contacts the screen. The “release” is an event indicating that the object (the pen 100) is separated from the screen.

The handwritten note application program 103b displays the page editing image for creating, viewing and editing a page in the handwritten document, on the touch screen display 12.

The display module 301 and the time-series information production module 302 receive a “touch (contact)”, “movement (slide)” or “release” event produced by the digitizer 12C, to thereby detect a handwriting input operation. The “touch (contact)” event includes coordinates of a contact position. The “movement (slide)” event includes coordinates of a contact position of the object after movement thereof. Therefore, the display module 301 and the time-series information production module 302 can input (receive) from the digitizer 12C, stroke data including a coordinate sequence corresponding to the shift of the contact position (i.e., stroke data associated with strokes given to form the handwritten document).

The display module 301 displays on the screen, the strokes given in handwriting by the user, in accordance with movement of the object (the pen 100) on the screen, which is detected with the digitizer 12C (i.e., in accordance with the input stroke data). The display module 301 displays on the page editing image, movement of the pen 100 which is detected while the pen 100 is in contact with the screen. That is, it displays movement of each of the strokes on the page editing image.

Based on the coordinate sequence included in the input stroke data as described above, the time-series information production module 302 produces a handwritten document including time-series information (coordinate data series) having such a structure as explained in detail with reference to FIG. 4. The time-series information production module 302 temporarily stores the produced handwritten document (time-series information) in the working memory 401.

The editing module 303 executes processing for editing a handwritten document (a page therein) which is being presently displayed. To be more specific, the editing module 303 executes an editing processing in accordance with a handwriting input operation and an editing operation performed by the user on the touch screen display 12, the editing processing including processing in which a new stroke or strokes (a new handwritten character, a new handwritten mark or the like) are added to the handwriting document being presently displayed, and processing in which at least one of a plurality of strokes, which are presently being displayed, is deleted or moved. Furthermore, the editing module 303 updates a handwritten document in the working memory 401 to reflect the result of the editing processing in the handwritten document (time-series information) being presently displayed.

The page storing module 304 stores in the storage medium 402, the handwritten document including the plurality of stroke data (time-series information) associated with the plurality of strokes in handwriting by the user with the pen 100. At this time, the page storing module 304 stores the handwritten document in association with an identifier (hereinafter referred to as a handwritten document ID) for identifying the handwritten document. As the storage medium 402 in which the handwritten document is stored, for example, a storage device provided in the tablet computer 10 may be applied, or that in the server (computer) 2 may be applied.

The page acquisition module 305 acquires an arbitrary handwritten document from the storage medium 402. The acquired handwritten document is sent to the display module 301. On the screen, the display module 301 displays a plurality of strokes associated with a plurality of stroke data included in the handwritten document.

The content association module 306 executes processing for associating content specified using information on a specific group of strokes included in the plurality of strokes given in handwriting (i.e., content associated with the specific group of strokes) with the specific group of stokes. It should be noted that the content associated with the group of strokes by the content association module 306 includes, for example, text data, voice data, image data, Web page data, etc.; however, it may include other data. Information indicating the content associated with the group of strokes given to form the handwritten document in the above manner (which will be hereinafter referred to as associated content information) is stored in the storage medium 402. It should be noted that the content association module 306 will be described later in detail.

Next, the display module 301 as shown in FIG. 11 will be explained. As shown in FIG. 11, the display module 301 includes a handwriting data input module 301A, a handwriting drawing module 301B and an content presentation module 301C.

As described above, in the touch screen display 12, a touch operation on the screen is detected by the touch panel 12B or the digitizer 12C. The handwriting data input module 301A is a module which inputs a detection signal output from the touch panel 12B or the digitizer 12C. The detection signal includes coordinate information (X, Y) on the touch position. By inputting such detection signals on a time-series basis, the handwriting data input module 301A inputs stroke data associated with strokes given in accordance with the handwriting input operation (i.e., given in handwriting). The stroke data (detection signal) input by the handwriting data input module 301A are supplied to the handwriting drawing module 301B.

The handwriting drawing module 301B is a module which draws and display locus (handwriting) of the handwriting input on the LCA 12A of the touch screen display 12. The handwriting drawing module 301B draws a line segment corresponding to the locus (handwriting) of the handwriting input on the basis of the stroke data (detection signal) from the handwriting data input module 301A.

In the case of displaying the handwritten document acquired by, e.g., the page acquisition module 305, the content presentation module 301C refers to the associated content information stored in the storage medium 402, and presents content associated with each of groups of strokes given to form the handwritten document.

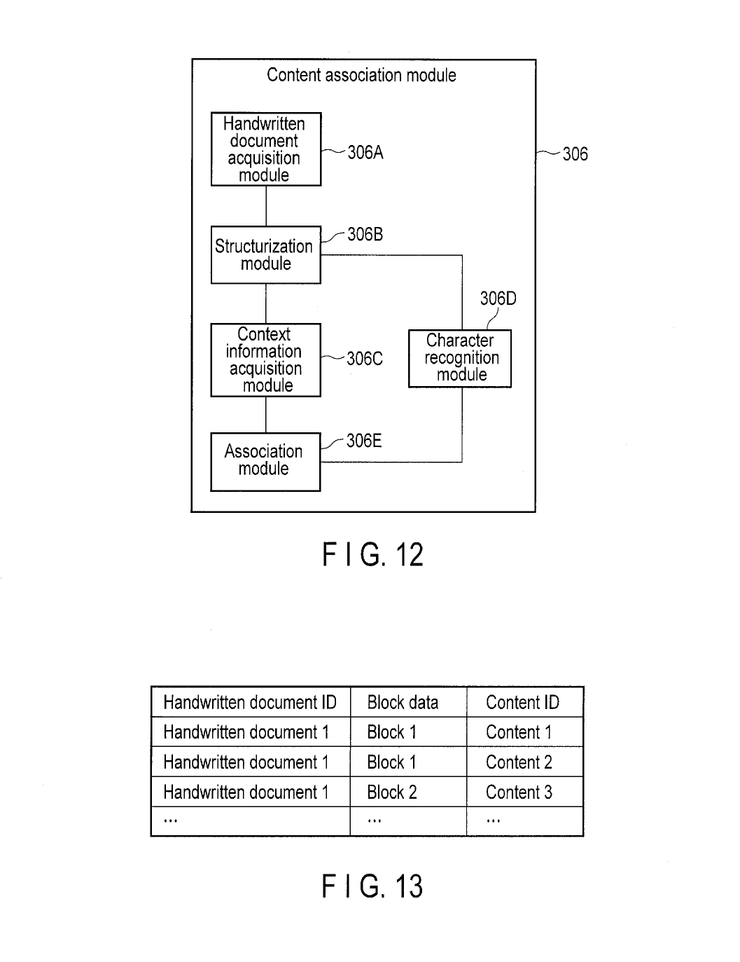

Next, the content association module 306 as shown in FIG. 11 will be explained in detail with reference to FIG. 12. As shown in FIG. 12, the content association module 306 includes a handwritten document acquisition module 306A, a structurization module 306B, a context information acquisition module 3060, a character recognition module 306D and an association module 306E.

The handwritten document acquisition module 306A acquires a handwritten document which is stored in the storage medium 402 by, e.g., the page storing module 304. The handwritten document includes a plurality of stroke data associated with a plurality of strokes given to form the handwritten document.

The structurization module 306B executes structurization processing on the handwritten document acquired by the handwritten document acquisition module 306A. Due to the structurization processing, the plurality of strokes given to form the handwritten document are divided into blocks in a predetermined unit.

On the basis of a group of stroke data associated with a group of strokes (a groups of strokes given to form the handwritten document) belonging to each of the blocks obtained by the structurization by the structurization module 306B, the context information acquisition module 306C acquires time at which inputting of the group of stroke data is started (which will be hereinafter referred to as an input starting time) and time at which the inputting of the group of stroke data is ended (which will be hereinafter referred to as an input ending time).

The character recognition module 306D executes character recognition processing on the group of strokes (e.g., a handwritten character string) belonging to each of the blocks obtained by the structurization by the structurization module 306B. In this case, the character recognition module 306D acquires a character string (text) or the like as a result of the character recognition processing.

In a time period between the input starting time and input ending time acquired by the context information acquisition module 306C, the association module 306E specifies content applied by the tablet computer 10 as content associated with the group of strokes belonging to each of the blocks obtained by the structurization by the structurization module 306B.

Furthermore, the association module 306E specifies content specified using the result of character recognition which is obtained by the character recognition module 306D, as the content associated with the group of strokes belonging to each of the blocks obtained by the structurization by the structurization module 306B.

In such a manner, the content specified by the association module 306E is associated with the group of strokes belonging to each of the blocks obtained by the structurization by the structurization module 306B. In this case, the association module 306E stores in the storage medium 402, associated content information indicating the content associated with the group of strokes. The content associated with the group of strokes in such a manner, as described later, can be displayed or reproduced by designation of the group of strokes by the user.

FIG. 13 shows an example of a data structure of the associated content information stored in the storage medium 402. As shown in FIG. 13, the associated content information includes handwritten document ID, block data, content ID, etc., such that they are associated with each other.

The handwritten document ID is an identifier for identifying the handwritten document acquired by the handwritten document acquisition module 306A. The block data is data indicating each of blocks (hereinafter referred to as blocks in the handwritten document) obtained by executing structurization processing on the handwritten document identified by the handwritten document ID. The block data includes, e.g., a coordinate data indicating a circumscribed rectangle of a block and a group of stroke data associated with a group of strokes belonging to the block. The content ID is an identifier (e.g., content name) for identifying content associated with (the group of strokes belonging to) the block indicated by the block data.

In an example as shown in FIG. 13, the associated content information includes the handwritten document ID “handwritten document 1”, the block data “block 1”, and the content ID “content 1” such that they are associated with each other. This associated content information indicate that content associated with (a group of strokes belonging to) the block 1 of the handwritten document 1 is content 1.

Also, the associated content information includes the handwritten document ID “handwriting document 1”, the block data “block 1” and the content ID “content 2” such that they are associated with each other. This associated content information indicate that content associated with (a group of strokes belonging to) the block 1 of the handwritten document 1 is content 2.

In such a manner, in this embodiment, a plurality of content (content 1 and content 2 in the above case) may be associated with a single block (the block 1 of the handwritten document 1).

It should be noted that although the above explanation is given with respect to the block 1 in the handwritten document 1, it is true of other blocks (for example, block 2) in the handwritten document 1 and blocks in another handwritten document, and their detailed explanations will thus be omitted.

An operation of the tablet computer 10 according to the embodiment will be explained. In the explanation, of all the processings to be executed by the tablet computer 10 according to the embodiment, content association processing and associated content presentation processing will be referred to.

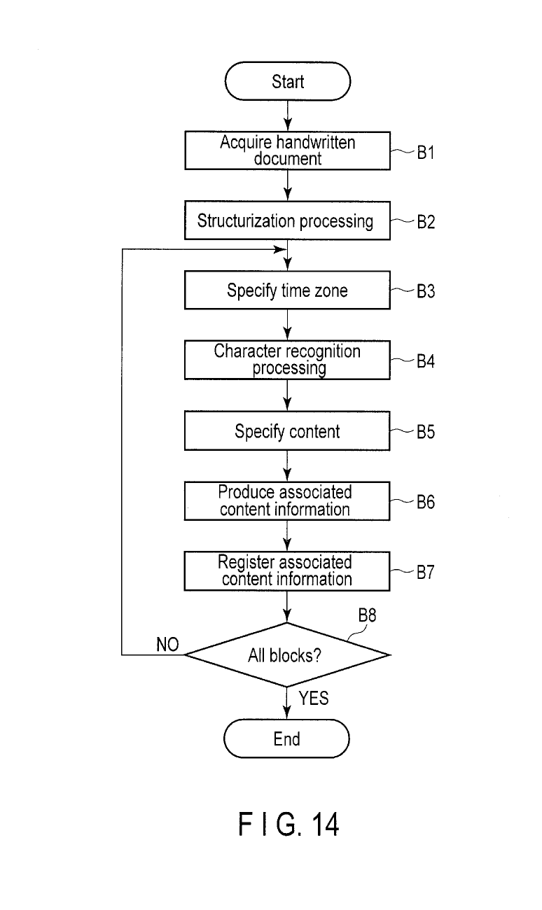

First of all, with reference to the flowchart of FIG. 14, a procedure of the content association processing will be explained. The content association processing is executed by the content association module 306, for example, when a document handwritten by the user is stored in the storage medium 402. In the following explanation to be given with reference to FIG. 14, the handwritten document to be stored in the storage medium 402 will be referred to as a target handwritten document.

In the content association processing, the handwritten document acquisition module 306A included in the content association module 306 acquires a target handwritten document (block B1). It should be noted that the target handwritten document acquired by the handwritten document acquisition module 306A includes a plurality of stroke data associated with a plurality of strokes constituting the target handwritten document.

The structurization module 306B executes the structurization processing on the target handwritten document acquired by the handwritten document acquisition module 306A (block B2). Due to the structurization processing, structurization is performed in units of one predetermined block on the basis of a plurality of stroke data included in the target handwritten document.

The structurization processing in block B2 will be explained in detail. In the structurization processing, the structurization module 306B divides a plurality of strokes constituting the handwritten document into blocks associated with respective lines (hereinafter referred to as line blocks). To be more specific, since (strokes associated with) stroke data included in the handwritten document are arranged in the order in which the associated strokes are given in handwriting, with respect to arrangement of the strokes, for example, if the distance between circumscribed rectangles of successive strokes is smaller than a threshold value, it is determined that the successive strokes belong to the same line block. On the other hand, if the above distance is equal to or greater than the threshold value, it is determined that the successive strokes belong to different line blocks. The strokes in the target handwritten document are successively subjected to the above processing, as a result of which the handwritten document is divided into blocks (line blocks) each of which includes a group of strokes constituting one of lines in the handwriting document.

Although the above explanation is given with respect to the case where a plurality of strokes in the target handwritten document are divided into line blocks, the plurality of strokes may be divided into blocks associated with respective paragraphs (hereinafter referred to as paragraph blocks), blocks associated with respective characters (hereinafter referred to as character blocks), blocks associated with respective terms (hereinafter referred to as term blocks) or the like.

If the above plurality of strokes are divided into paragraph blocks, for example, on a plane of a target handwritten document, all strokes in line blocks with respect to a short side direction thereof are reflected and a frequency of occurrence of strokes in a given section is calculated, to thereby obtain a histogram. Since such a histogram has a plurality of modal values (peak values), in structurization, the strokes can be divided into blocks (paragraph blocks) associated with respective peak values.

In structurization, if the strokes are divided into character blocks, an average value of short side of circumscribed rectangles of the above line blocks is determined as the size of a single character. Furthermore, the circumscribed rectangles of the stokes are subjected to AND processing in the order in which the strokes are given in handwriting, and the circumscribed rectangles of successive strokes are combined into a single circumscribed rectangle. Then, if the single circumscribed rectangle obtained in the above combining processing is greater than the size of the above single character in a longitudinal direction of the line blocks, it is determined that the successive strokes (i.e., the strokes not yet subjected to the combining processing) belong to different character blocks. On the other hand, if the above single circumscribed rectangle is not greater than the size of the single character, it is determined that the successive strokes belong to the same character block. The strokes in the target handwritten document are successively subjected to the above processing, as a result of which the target handwritten document is divided into blocks (character blocks) each of which includes a group of strokes constituting one of characters in the target handwritten document.

If the above plurality of blocks are divided into term blocks, for example, character recognition processing is performed on (the plurality of strokes in) the handwritten document, and the plurality of strokes therein are converted into character strings. Then, when being subjected to, e.g., a morphological analysis, the character strings are divided into terms. In this case, a group of strokes recognized in character as each of the terms obtained by the above division are determined as strokes belonging to a single block (i.e., a term block). It should be noted that the term block may be calculated based on, for example, the above character blocks.

That is, it suffices that the structurization processing in the block B2 as described above is processing for dividing the target handwritten document (a plurality of strokes therein) into a plurality of blocks in predetermined unit. To be more specific, in the structurization processing, it suffices that the target handwritten document (a plurality of strokes therein) is divided into blocks in units of at least one of line, paragraph, character and term.

Then, each of the blocks obtained in the structurization in the block B2 is subjected to the following processings of blocks B3-B7. The block to be subjected to the processings of the blocks B3-B7 will be hereinafter referred to as a target block.

The context information acquisition module 306C specifies a time period in which a group of strokes belonging to a target block were handwritten (i.e., a time period in which a group of stroke data associated with the above group of strokes were input) (block B3).

In this case, the context information acquisition module 306C specifies a first one and a last one of the handwritten strokes belonging to the target block on the basis of the group of stroke data (time-series information) associated with the strokes belonging to the target block. Then, the context information acquisition module 306C acquires time (i.e., input starting time) associated with time stamp information T added to a stroke data associated with the specified first handwritten stroke. Also, the context information acquisition module 306C acquires time (i.e., input ending time) associated with time stamp information T added to stroke data associated with the last handwritten stroke. Based on the acquired input starting time and ending time (i.e., context information), the context information acquisition module 306C specifies a time period from the input starting time to the input ending time as a time period in which the group of strokes belonging to the target block were handwritten (which will be hereinafter referred to as an input time period for the target block).

Furthermore, the character recognition module 306D executes character recognition processing on the group of strokes belonging to the target block (block B4). In this processing, the group of strokes belonging to the target block are converted into a character string, a symbol mark or the like, and the character recognition module 306D acquires the character string, the symbol mark or the like as a result of character recognition.

Then, the association module 306E specifies content (hereinafter referred to as associated content) associated with (a group of strokes belonging to) the target block (block B5).

In this case, the association module 306E specifies one or more content included in a plurality of content stored in, e.g., the tablet computer 10 (i.e., content held by the user), as associated content, the one or more content being applied (used) in the tablet computer 10 in the input time period for the target block (i.e., the one or more content being applied in handwriting the group of strokes belonging to the target block).

The handwritten content includes, for example, a file opened in the input time period for the target block in the tablet computer 10 and a file produced in the input time period for the target block (e.g., a document file, a spreadsheet file, a sound file, a music file, a movie file or the like). A time period in which such a kind of file is opened in the tablet computer 10, etc., are managed in the file.

The associated content does not need to be applied throughout the input time period for the target block, and for example, the associated content may be content applied in a given time period in the input time period or applied at the input starting time or the input ending time. Furthermore, a certain margin may be given to the input time period from the input starting time to the input ending time by adding to the time period, a predetermined time period precedent to the input starting time or subsequent to the input ending time.

Also, the association module 306E specifies the associated content based on the result of character recognition (i.e., the character string or symbol mark into which the group of strokes belonging to the target block are converted) by the character recognition module 306D.

To be more specific, if the character string is acquired as the result of character recognition, for example, of the content stored in the tablet computer 10, content whose name contains the character string (e.g., a file whose name contains the character string) is specified as the associated content by the association module 306E. On the other hand, if the symbol mark is acquired as the result of character recognition, no associated content is specified.

It should be noted that in the above block B2, if the plurality of strokes in the target handwritten document are divided into line blocks or paragraph blocks, there is a case where the character string acquired as the result of character recognition is long. In such a case, it may be set that a file whose name contains a term or the like acquired by performing a morphological analysis processing on the character string acquired as the result of character recognition is specified as the associated content. Furthermore, if the plurality of strokes included in the target handwritten document are divided into, e.g., paragraph blocks, a keyword (e.g., a term the appearance frequency of which is high) is extracted from the character string acquired as the result of character recognition, and a file whose name contains the keyword is specified as associated content.

If the associated content is specified in the block B5 in the above manner, the association module 306E produces associated content information indicating the associated content (block B6). To be more specific, the association module 306E produces associated content information including a handwritten document ID for identifying the target handwritten document, block data indicating the target block (i.e., coordinate data indicating a circumscribed rectangle of the target block and a group of stroke data associated with a group of strokes belonging to the target block) and content ID for identifying the associated content specified in the block B5.

The association module 306E registers (stores) the produced associated content information in the storage medium 402 (block B7).

Then, it is determined whether or not all the blocks obtained in the structurization in the block B2 are subjected to the processings of blocks B3-B7 (block B8).

If it is determined that not all the blocks are subjected to the above processing (NO in the block B8), the processing to be executed is returned to the processing of the block B3, the processings from that of the block B3 onward are repeated. In this case, the processing are executed on a block not subjected to the processings of the blocks B3-B7, as target blocks.

On the other hand, if it is determined that all the blocks are subjected to the above processings, the content associating processing is ended.

In such a manner, due to the content associating processing, it is possible to associate associated content with each of blocks (each of groups of strokes belonging thereto) into which the handwriting document is divided by performing the structurization processing thereon.

It should be noted that although it is explained above that the content associating processing as shown in FIG. 14 specifies the associated content based on both the input time period for the target block and the result of character recognition, it may be set that the associated content is specified based on only one of the input time period for the target block and the result of character recognition. Also, it should be noted that in the case of specifying the associated content based on only the input time period for the target block, the processing of the block B4 may be omitted. Similarly, in the case of specifying the associated content based on only the result of character recognition, the processing of the block B3 may be omitted. Furthermore, in the embodiment, if the associated content is specified based on the group of strokes belonging to the target block, another processing may be executed.

Furthermore, it is explained above that in the processing of the block B5 as shown in FIG. 14, content applied in the time period (input time period) from the input starting time to the input ending time acquired as context information is specified as the associated content; however, another information, e.g., information on a place (e.g., a facility) where the group of strokes belonging to the target block were handwritten, may be acquired as context information. For example, if information on the place (e.g., a facility) where the group of strokes belonging to the target block were handwritten is acquired, it suffices that content associated with the place (e.g., a Web page of the facility) is specified as the associated content.

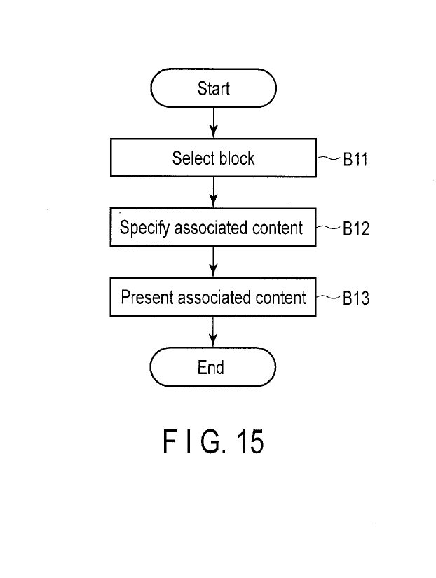

Next, a procedure of the associated content presentation processing will be explained with reference to the flowchart of FIG. 15. The associated content presentation processing is executed by an content presentation module 301C when a handwritten document stored in the storage medium 402 is displayed on the screen of the tablet computer 10. In the following explanation to be given with reference to FIG. 15, the handwritten document displayed on the screen of the tablet computer 10 will be referred to as a target handwritten document.

Suppose the target handwritten document has been subjected to the content association processing as shown in FIG. 14. In other words, suppose associated content has been respectively associated with blocks (which will be hereinafter referred to as blocks of the target handwritten document) which are obtained by executing the structurization processing on the target handwritten document.

Also, it should be noted that if the target handwritten document is displayed on the screen of the tablet computer 10, the user can perform an operation (e.g., a touch operation) for selecting at least one of the blocks of the target handwritten document.

In this case, the content presentation module 301C receives, e.g., a “touch (contact)” event generated by the digitizer 12C, and selects a block in which coordinates of the contact position, which are included in the event, are located in an area of its circumscribed rectangle (block B11). It should be noted that (the area of) the circumscribed rectangle of each of the blocks of the target handwritten document is specified by (coordinate data included in) block data which is included in associated content information in association with a handwritten ID for identifying the target handwritten document. The block selected by the content presentation module 301C will be hereinafter referred to as a selected block.

Next, the content presentation module 301C refers to the associated content information stored in the storage medium 402 to specify associated content associated with the selected block (block B12). To be more specific, the content presentation module 301C acquires a content ID included in the associated content information in association with the handwritten document ID for identifying the target handwritten document and block data indicating the selected block. The content presentation module 301C specifies content identified by the acquired content ID, as the associated content associated with the selected block.

The content presentation module 301C displays (presents) the specified associated content on the screen of the tablet computer 10 (block B13).

Due to such an associated content presentation processing, when the target handwritten document is displayed, it is also possible to display (present) associated content associated with a block of the target handwritten document which is selected by the user.

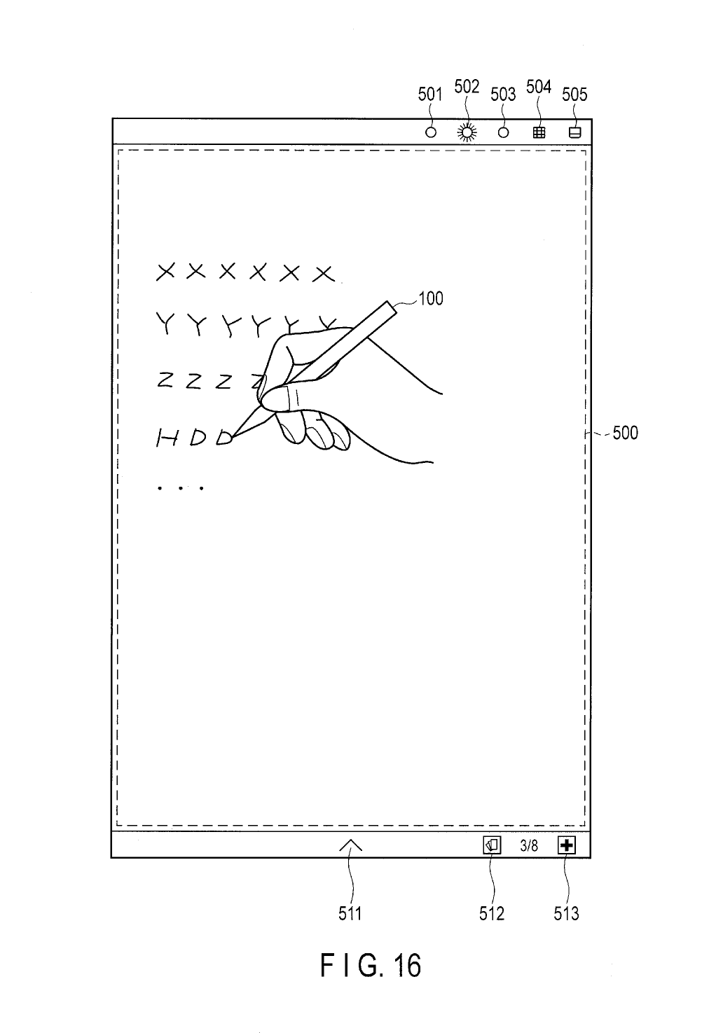

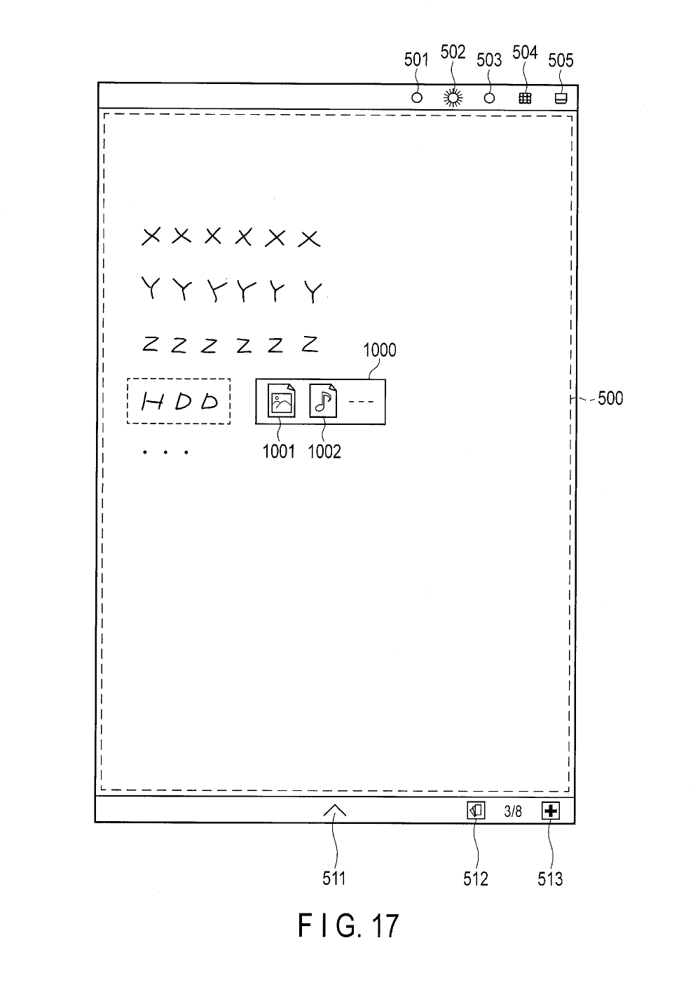

An example of an image (page editing image) displayed on the screen of the tablet computer 10 in the case of presenting associated content will be explained with reference to FIGS. 16 and 17. It should be noted that in FIGS. 16 and 17, portions identical to those in FIG. 9 described above are denoted by the same reference numerals as in FIG. 9.

First of all, suppose on an image in which such a target handwritten document as shown in FIG. 16 is displayed, the user performs an operation (touch operation) for selecting a block to which, e.g., the handwritten character string “HDD” (a group of strokes in the character string) belongs to.

In this case, as shown in FIG. 17, in the vicinity of the block to which the handwritten character string “HDD” belongs, an associated content presentation area 1000 is displayed. In the associated content presentation area 1000, associated content associated with the handwritten character string “HDD” (the block to which the character string belongs) is presented.

In an example shown in FIG. 17, in the associated content presentation area 1000, icons 1001 and 1002, etc. are indicated, the icon 1001 being associated with an image file produced in a time period (e.g., a time period made to have a given margin) in which the character string “HDD” was handwritten, the icon 1002 being associated with a voice file produced in the time period. The image file includes, e.g., an image (e.g., an image of a whiteboard used in a conference) picked up by a camera provided in the tablet computer 10, for example, in the case where the tablet computer 10 is used in a conference in a company. Similarly, the voice file includes voice (e.g., voice in a conference) recorded by a microphone provided in the tablet computer 10, for example, in the case where the tablet computer 10 is used in the conference in the company.

It should be noted that the associated content presented in the associated content presentation area 1000 may be content (e.g., an image file or a voice file) produced by an external device or the like in the time period in which the character string “HDD” was handwritten.

Furthermore, although it is explained above that the icons 1001 and 1002 associated with the image file and voice file produced in the time period in which the character string “HDD” is handwritten are presented, for example, an icon associated with a file opened in the time period or a file whose name includes a character string acquired as the result of the above character recognition may be presented.

It should be noted that the user can perform an operation (touch operation) for selecting the icon 1001 or the icon 1002 presented in the associated content presentation area 1000 as shown in FIG. 17. When the user selects, e.g., the icon 1001 presented in the associated content presentation area 1000 in the above manner, the image file associated with the icon 1001 is opened on the tablet computer 10, and can thus be viewed by the user.

As described above, in the embodiment, stroke data (groups) associated with a plurality of groups of strokes (first and second groups of strokes) included in a handwritten document is input, and associated content (first content and second content) specified based on the groups of strokes is associated with the groups of strokes (blocks to which they belong), respectively. Furthermore, in the embodiment, in the case of displaying the handwritten document, at least one of associated content associated with (the groups of strokes belonging to) the blocks is presented (for example, associated content associated with a block selected by the user is presented).

In the embodiment, by virtue of the above structure, it is possible to access associated content with reference to (the groups of strokes constituting) a handwritten document. Therefore, for example, with respect to each of handwritten documents, it is not necessary to manage associated content together, and the user can thus perform an efficient operation. Hence, according to the embodiment, it is possible to improve the convenience of the user.

To be more specific, in the embodiment, content applied (used) in a time period (first time period, second time period) in which stroke data associated with groups of strokes in a handwritten document were input is presented as associated content. In the embodiment, by virtue of such a structure, the user can view the handwritten document and the content applied when the groups of strokes in the handwritten document were handwritten, and can thus easily understand why the handwritten document was created, etc.

Furthermore, in the embodiment, content specified based on results of character recognition (results of first character recognition and second character recognition) with respect to the groups of strokes in the handwritten document is presented as associated content. In the embodiment, by virtue of such a structure, when the handwritten document is viewed, content (considered to be) associated with (handwritten character strings represented by) the groups of strokes in the handwritten document can also be viewed.

In addition, in the embodiment, content produced in time periods (first and second time periods) in which stroke data associated with the groups of strokes in the handwritten document were input is presented as associated content. In the embodiment, by virtue of such a structure, for example, if the tablet computer 10 is used in a conference or the like as described above, an image (file) of a whiteboard used in the conference, voice (file) recorded during the conference, etc., can be confirmed when the handwritten document is viewed later.

It should be noted that although with respect to the embodiment, it is explained that when a handwritten document is created, and stored in the storage medium 402, associated content is automatically associated with (groups of strokes belonging to) blocks in the handwritten document, for example, associated content selected in accordance with, e.g., an operation by the user, may be associated. Also, it is possible to provide a structure in which association of associated content with the blocks in the handwritten document is canceled in accordance with an operation of the user. It should be noted that for example, such association of associated content by manual operation of the user with blocks of a handwritten document can be performed using a menu or like which is displayed, for example, when a block in the handwritten document is specified (selected).

Furthermore, with respect to the embodiment, although it is explained above that associated content associated with groups of strokes (blocks to which they belong) in a created handwritten document is presented in the case where the created handwritten document is re-displayed, a history of past associated content may be presented in the case where a new handwritten document is created.

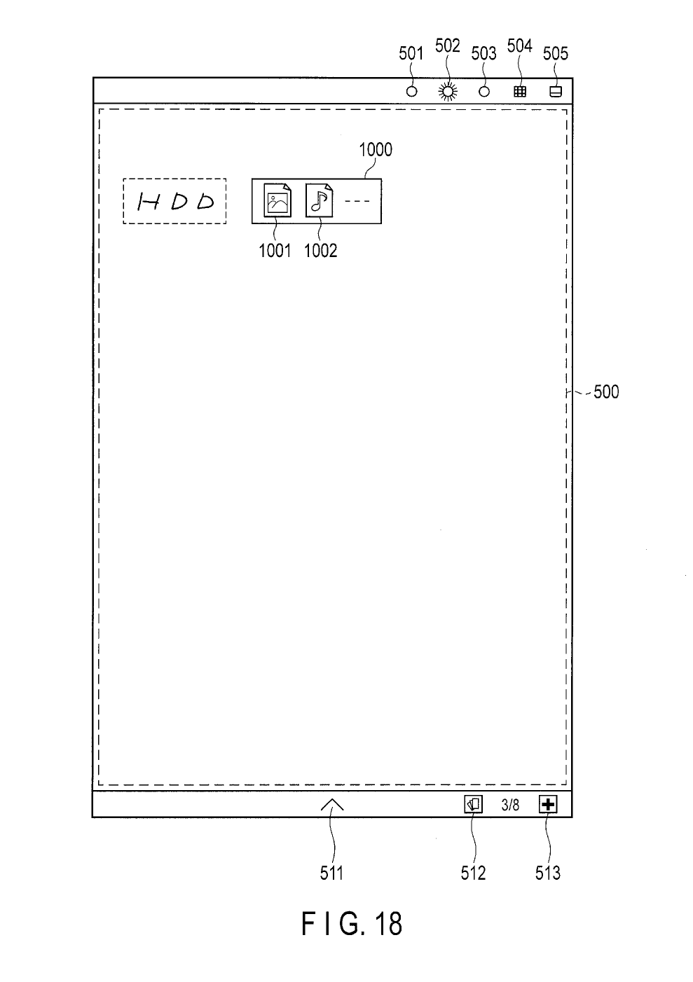

To be more specific, as shown in FIG. 18, suppose the character string “HDD” (a group of strokes therein) is handwritten by the user in the case of creating a new handwritten document (pages thereof). In the case where (stroke data associated with) the character string “HDD” handwritten as described above is input to the tablet computer 10, for example, the content presentation module 301C refers to associated content information stored in the storage medium 402 to specify content (third content) associated with a group of strokes (third stroke group) identical to or similar to those in the handwritten character string “HDD”. It should be noted that in calculation of a similarity between a group of stroke in the handwritten character string “HDD” and another kind of strokes, for example, a DP matching, etc., can be applied. Such specified content is presented in the associated content presentation area 1000 as shown in FIG. 18, as content which was associated with the handwritten character string “HDD” (i.e., a history of associated content). In such a manner, the content presented in the associated content presentation area 1000 can be displayed or reproduced, by, e.g., specifying of the content by the user. Although it is omitted in FIG. 18, in the above case, the content presented in the associated content presentation area 1000 may be displayed therein in such a manner as to enable the user to easily understand that the presented content is indicated as past associated content in a history.

Although the above explanation is given only regarding the case where the character string “HDD” is handwritten, even in the case where another character string (a second group of strokes) is handwritten, a history of associated content can be presented as long as content (fourth content) associated with a group of strokes (fourth stroke group) identical or similar to the above other character string is present.

By virtue of the above structure, for example, the following advantage is obtained:

For example, there is a case where although the user remembers a handwritten character string (a group of strokes) with which a desired associated content is associated, it is troublesome to search for a handwritten document including the handwritten character string since a larger number of handwritten documents are stored. However, even in such a case, the user can search for the associated content associated with the handwritten character string by handwriting the character string, and can thus easily confirm the associated content.

It should be noted that a history of associated content may be presented just after the character string is handwritten, or may be presented when the user instructs the history to be presented. Also, it is possible to provide a structure in which in the case where the history of associated content is displayed at the time of creating a new handwritten document as described above, associated content presented in the history is associated with (a character string handwritten on) the new handwritten document, e.g., in accordance with an operation of the user.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A method comprising:
receiving data associated with a first group of strokes and a second group of strokes of handwriting;
associating first content with the first group of strokes, the first content determined based on information associated with the first group of strokes; and
associating second content with the second group of strokes, the second content determined based on information associated with the second group of strokes,
wherein
the first content is displayable or reproducible by a selection of the first group of strokes, and
the second content is displayable or reproducible by a selection of the second group of strokes.

2. The method of claim 1, wherein:
the first content comprises one or more content applied in a first time period in which first stroke data associated with the first group of strokes is received; and
the second content comprises one or more content applied in a second time period in which second stroke data associated with the second group of strokes is received.

3. The method of claim 1, wherein:
the first content comprises content determined based on a result of first character recognition associated with the first group of strokes; and
the second content comprises content determined based on a result of second character recognition associated with the second group of strokes.

4. The method of claim 1, wherein:
the first content comprises one or more content produced in a first time period in which first stroke data associated with the first group of strokes is received; and
the second content comprises one or more content produced in a second time period in which second stroke data associated with the second group of strokes is received.

5. The method of claim 1, wherein:
when first stroke data associated with the first group of strokes is received, third content associated with a third group of strokes which are the same as or have a threshold degree of similarity to the first group of strokes is displayable or reproducible; and
when second stroke data associated with the second group of strokes is received, fourth content associated with a fourth group of strokes which are the same as or have a threshold degree of similarity to the second group of strokes is displayable or reproducible.

6. An electronic apparatus comprising:
circuitry configured to:
receive data associated with a first group of strokes and a second group of strokes of handwriting;
associate first content with the first group of strokes, the first content determined based on information associated with the first group of strokes; and
associate second content with the second group of strokes, the second content determined based on information associated with the second group of strokes,
wherein
the first content is displayable or reproducible by a selection of the first group of strokes, and
the second content is displayable or reproducible by a selection of the second group of strokes.

7. The electronic apparatus of claim 6, wherein:
the first content comprises one or more content applied in a first time period in which first stroke data associated with the first group of strokes is received; and
the second content comprises one or more content applied in a second time period in which second stroke data associated with the second group of strokes is received.

8. The electronic apparatus of claim 6, wherein:
the first content comprises content determined based on a result of first character recognition associated with the first group of strokes; and
the second content comprises content determined based on a result of second character recognition associated with the second group of strokes.

9. The electronic apparatus of claim 6, wherein:
the first content comprises one or more content produced in a first time period in which first stroke data associated with the first group of strokes is received; and
the second content comprises one or more content produced in a second time period in which second stroke data associated with the second group of strokes is received.

10. The electronic apparatus of claim 6, wherein:
when first stroke data associated with the first group of strokes is received, third content associated with a third group of strokes which are the same as or have a threshold degree of similarity to the first group of strokes is displayable or reproducible; and
when second stroke data associated with the second group of strokes is received, fourth content associated with a fourth group of strokes which are the same as or have a threshold degree of similarity to the second group of strokes is displayable or reproducible.

11. A non-transitory computer-readable storage medium having stored thereon a computer program which is executable by a computer, the computer program comprising instructions capable of causing the computer to execute functions of:
receiving data associated with a first group of strokes and a second group of strokes of handwriting;
associating first content with the first group of strokes, the first content determined based on information associated with the first group of stokes; and
associating second content with the second group of strokes, the second content determined based on information associated with the second group of strokes,
wherein
the first content is displayable or reproducible by a selection of the first group of strokes, and
the second content is displayable or reproducible by a selection of the second group of strokes.

12. The storage medium of claim 11, wherein:
the first content comprises one or more content applied in a first time period in which first stroke data associated with the first group of strokes is received; and
the second content comprises one or more content applied in a second time period in which second stroke data associated with the second group of strokes is received.

13. The storage medium of claim 11, wherein:
the first content comprises content determined based on a result of first character recognition associated with the first group of strokes; and
the second content comprises content s determined based on a result of second character recognition associated with the second group of strokes.

14. The storage medium of claim 11, wherein:
the first content comprises one or more content produced in a first time period in which first stroke data associated with the first group of strokes is received; and
the second content comprises one or more content produced in a second time period in which second stroke data associated with the second group of strokes is received.

15. The storage medium of claim 11, wherein:
when first stroke data associated with the first group of strokes is received, third content associated with a third group of strokes which are the same as or have a threshold degree of similarity to the first group of strokes is displayable or reproducible; and
when second stroke data associated with the second group of strokes is received, fourth content associated with a fourth group of strokes which are the same as or have a threshold degree of similarity to the second group of strokes is displayable or reproducible.
